(19) United States
(12) Patent Application Publication
(10) Pub. No.: US 2016/0286837 A1
(43) Pub. Date: Oct. 6, 2016

(54) SYSTEM AND METHOD OF CONVERTING RECIPES FOR AN AUTOMATIC MEAL PREPARATION APPARATUS

(71) Applicant: Kitchen Mate Inc., Toronto (CA)

(72) Inventors: Yang YU, TORONTO (CA); Yousuf CHOWDHARY, MAPLE (CA)

(21) Appl. No.: 15/091,928

(22) Filed: Apr. 6, 2016

Related U.S. Application Data
(60) Provisional application No. 62/143,271, filed on Apr. 6, 2015.

(51) Int. Cl. B65B 55/00

(52) U.S. Cl. CPC A23L 1/0128; A23V 2002/00

(57) ABSTRACT

A method of converting a recipe is provided for use with an automatic meal preparation apparatus, which includes separating text of a recipe into an ingredients portion and a directions portion, parsing each portion using standard terms, quantities and units, and converting the instructions into discrete steps related to the heating, dispensing, stirring and cooking operations of the apparatus.

### REFERENCE TO RELATED APPLICATIONS

The present invention claims the benefit of priority to U.S. Provisional Patent Application Ser. No. 62/143,271 filed on Apr. 6, 2015, which is hereby incorporated herein by reference in its entirety.

### FIELD OF INVENTION

The invention relates to automated devices for meal preparation and in particular relates to methods of converting recipes for use in such devices.

### BACKGROUND

Preparing a homemade meal is not always straightforward. It not only involves actually cooking the food, but also deciding what to cook, and knowing how to cook it. Often, this involves following recipes precisely, sourcing the right ingredients and spices, and adding the precise quantities at the right time so that each ingredient is cooked to perfection. Failure to follow the recipe may lead to undesirable outcomes. If everything is performed accordingly, a homemade meal is not only delicious, but also very nutritious. While cooking can be an enjoyable experience, in today's fast paced world, it is often a rather tedious chore.

Recipes for many types of meals have been around for awhile and were passed orally from one generation to another. Recipe books focused on many different types of cuisines are available like cookbooks for Chinese stir fries, Indian curries, Mexican etc. Cookbooks are also available for different types of meals and delicacies including for example recipe books for seafood, desserts, sandwiches, soups, etc. People generally share such books or recipes that they have tried from the aforementioned sources.

In recent years, books and paper based recipe collections have evolved to the digital realm with recipe search engines like Foodily which is also considered a social recipe network. Similarly apps for recipes also exist that can be installed on mobile devices like tablets or Smartphones, e.g. “Yummly Recipes”, “Food Network in the Kitchen”, “PetitChef” etc.

But neither cookbooks, recipe search engines, nor recipe apps, prepare the meals automatically, nor can these recipes can be used with any devices that can prepare meals automatically. Meal preparation is still a very laborious and time consuming activity that also requires a certain skill.

Making food quickly and well can be easy once one has mastered how to cook; but it is a learned skill, the acquisition of which takes time, practice, patience and the acceptance of mistakes. To cook whole foods at a pace that can match box-meal offerings, one needs to know how to make substitutions on the fly; how to doctor a dish that has been over salted or over spiced; how to select produce and know for how long one has to cook it, amongst other variables.

Prior art methods lack the ability to convert favorite recipes so that an automated meal preparation apparatus can automatically prepare them. Thus we note that prior art methods have inherent limitations and are in need of improvement.

It would be desirable to have methods of converting recipes to allow them to be used with an automatic meal preparation apparatus.

### SUMMARY

Broadly stated, the invention provides a system and a method of automatic meal preparation that allows for an “eating without having to cook” experience. Using the apparatus, cooking from whole ingredients can be easy, cost-effective and healthy.

The automatic meal preparation apparatus is capable of preparing different recipes from various cuisines by using spices that are supplied in removable cartridges. The automatic meal preparation apparatus is computer assisted for controlling the time of cooking, intensity of heat, amount of spices, combination of spices, timing when individual raw ingredients are added to the cooking vessel etc. One type of apparatus which can be beneficially used for the present method is disclosed in applicants' previously filed USPTO patent application Ser. No. 14/952,142 filed on Nov. 25, 2015, the contents of which are incorporated herein by reference.

A system and method may be provided for converting recipes for the Automatic Meal Preparation Apparatus (AMPA). A recipe is first acquired that is “user understandable” and cannot be used by the Automatic Meal Preparation Apparatus (AMPA) directly, e.g. a recipe in a cookbook, a recipe book, a website, a hand written recipe from a friend, a recipe search engine, a recipe app etc. This recipe may be added into an app or a Recipe Portal that implements the disclosed invention.

The user understandable recipe can then be translated to an automatic meal preparation apparatus (AMPA) understandable recipe that can be used by the apparatus to prepare a meal automatically. The AMPA understandable recipe can be saved either in the app, the Recipe Portal, the apparatus itself or any combination of the aforementioned.

Preferably, the User Understandable Recipe is converted into an AMPA Understandable Recipe by first looking at the directions; separating the ingredients, their quantities and meal preparation instructions; and using a database that stores the different ingredients into an ordered list of fresh ingredients and their quantities (e.g. meats and vegetables); a list of spices and their quantities (e.g. salt ½ teaspoon, black pepper ¼ teaspoon, red chillies ⅓ teaspoon, cumin ½ teaspoon etc.). and meal preparation instructions e.g. order of adding ingredients, temperatures for cooking, duration for cooking, instructions for mixing the ingredients e.g. add meat, blanch over medium heat for 10 minutes while stirring gently.

The database may include but is not limited to the following: a list of spices and spice cartridges and their equivalents; a list of different meats e.g. beef, lamb, chicken, turkey, fish and their preparation instructions e.g. fillet, cube, mince etc. and cooking temperature and duration thresholds; a list of vegetables e.g. potatoes, cauliflower, zucchini, tomatoes, onions, etc. and their preparation instructions e.g. slice, cube, puree, chop etc. and cooking temperature and duration thresholds; a list of oils and sauces and any other kind of ingredients that may be used in meal preparations. The database may also include the conversion factors for the spices e.g. 1 teaspoon is equal to 5 g dry, 1 teaspoon is equal to 5 ml liquid and 1 tablespoon is equal to 15 ml liquid etc.; a list of heating, temperature and duration conversions e.g. medium heat for 5 minutes may be converted to 45% of the induction heat for 4 minutes etc.; a list of stirring and mixing instructions and conversions e.g. stir gently for 3 minute may imply stirring at 10 RMP in clockwise direction, while stir vigorously for 5 minutes may imply stirring at 20 RMP first in clockwise and then in a anticlockwise direction.

A central database may be provided for storing and categorizing the AMPA readable recipes and making these recipes available for download by users.

A bot may also acquire one or more recipes into the system. The system may be accessible via the internet and a user may use a computing device like a tablet to enter (step by step)/upload a recipe to the portal.

The acquired recipe may be converted into format compatible with AMPA. There may be checks and balances for cooking time, cooking temperatures and spice quantities, etc. The cooking time and temperature may be dependent on the type of meat and its quantity.

In one embodiment, the recipe may be tested by preparing a meal in the Automatic Meal Preparation Apparatus (AMPA). Such a recipe testing process may be manual such that a person (tester) tests the recipe by using the Automatic Meal Preparation Apparatus (AMPA), or there may be automated methods of validating a converted recipe for certification, or this may be crowdsourced to the user community (e.g. by ratings or popularity).

The recipe may be certified if the resultant meal was up to standard. In one embodiment, the recipe certification process may be manual such that a person (tester) tests the recipe by using the Automatic Meal Preparation Apparatus (AMPA) and then tastes the resultant meal. The certification process may follow a given standard which may have criteria that needs to be satisfied before a recipe can be considered certified.

Optionally, a signature may be embedded in the recipe once it has been tested and certified. The signature may be encrypted so that it may not be altered or tempered with. In one embodiment, the Automatic Meal Preparation Apparatus may check for the signature to ensure that the recipe is certified and will prepare a meal that will be up to standard.

The converted (and optionally certified) recipe may be made available for general download to the user base. The recipe may be categorized and put on the portal for the general public to download and use in the Automatic Meal Preparation Apparatus (AMPA).

A user may be able to acquire recipes from anywhere e.g. from a cookbook, a recipe book, a website, a hand written recipe from a friend, etc. and may be able to add it to the Recipe Portal for conversion. The converted recipe may be sent to the user's AMPA directly or may be sent to an app installed on the user's mobile device from where the user may be able to transfer it to the AMPA.

According to a first aspect of the invention, a method is provided for converting a recipe for use with an automatic meal preparation apparatus. After text of a recipe is received, the recipe is separated into an ingredients portion and a directions portion. Within the ingredients portion of the recipe, each ingredient is parsed to replace it with a standard term from a database; a quantity and unit of the ingredient is standardized; and at least one spice/sauce is identified from a from a spice/sauce cartridge database associated with the apparatus. Within the directions portion of the recipe, the instructions are parsed into discrete steps including standard term instructions for: selectively heating a heating element of the apparatus at pre-determined times; selectively dispensing at least a portion of the ingredients by releasing them from the compartment into a cooking vessel in communication with the heating element at a pre-determined time; selectively dispensing a pre-determined measure of the spice/sauce from at least one spice/sauce cartridge by releasing it into the cooking vessel at a pre-determined time; and stirring and cooking the ingredients and the spice/sauce in the vessel for a specified duration, in accordance with the recipe.

A conversion factor may be applied to the quantity and the unit. For example, the conversion factor may be used to change the quantity or servings of the recipe. A substitution may be applied according to a database of known substitutions.

Preferably, the parsing and standardizing steps include converting the text to a machine readable format, encoding or notation. In one embodiment, the format, encoding or notation comprises XML or JSON.

A converted recipe may be stored in a database for use with the apparatus. The converted recipe may be categorized. Further, the converted recipe may be sent directly to an apparatus, or made available for download (directly or indirectly) to an apparatus. The converted recipe may be sent for certification and/or testing. The converted recipe may also be personalized by a user of the apparatus prior to use.

A step of the converted recipe may include a command selected from the group consisting of: heat/temp, wait/delay, inject, dispense, stir, cut, and drain.

The steps may include a sequence.

The stir command may convert to an RPM of a stirring arm of the apparatus, and a direction or directions to stir.

An ingredient of the converted recipe may include an intended form factor of the ingredient before it is placed in the apparatus.

In some embodiments, a step of the converted recipe includes an addition of water or steam or oil from a reservoir.

A step of the converted recipe may include an instruction for venting the apparatus or controlling the fan speed of the apparatus.

The recipe may be acquired by a bot or by a user entering a recipe (or other methods of acquiring). The method may be carried out at least in part on a portal, on an app, or on an automatic meal preparation apparatus. The converted recipe may be saved at least in part on a portal, on an app, or on an automatic meal preparation apparatus. After saving, the converted recipe may be made available for sharing.

The method may include charging a user for conversion of the recipe.

### BRIEF DESCRIPTION OF THE FIGURES

FIG. 1 is a flow diagram of an embodiment of a method of converting recipes for an automatic meal preparation apparatus.

FIG. 2 is a perspective view of a preferred embodiment of the automatic meal preparation apparatus.

FIG. 3 is a view of a spice/sauce compartment for the automatic meal preparation apparatus shown in FIG. 2.

FIG. 4 is a view of a spice/sauce cartridge for use with the automatic meal preparation apparatus shown in FIG. 2.

FIG. 5 is a flow diagram for converting ingredients and directions portions of a user understandable recipe to an AMPA understandable recipe.

FIG. 6 is a diagram of preferred word reference tables for recipe parsing.

FIG. 7 is a flow diagram of a method of certifying a recipe.

FIG. 8 is a flow diagram of a method of user entry of a recipe to be converted.

### DETAILED DESCRIPTION

Before embodiments are explained in detail, it is to be understood that the invention is not limited in its application to the details of the examples set forth in the following descriptions or illustrated drawings. It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein.

Furthermore, this description is not to be considered as limiting the scope of the embodiments described herein in any way, but rather as merely describing the implementation of the various embodiments described herein. The invention is capable of other embodiments and of being practiced or carried out for a variety of applications and in various ways. Also, it is to be understood that the phraseology and terminology used herein is for the purpose of description and should not be regarded as limiting.

Before embodiments of the hardware and software modules or flow charts are described in detail, it should be noted that the invention is not limited to any particular form or shape or software language described or implied in the figures and that a variety of alternative software languages may be used for implementation.

It should also be understood that many components and items are illustrated and described as if they were hardware elements, as is common practice within the art. However, one of ordinary skill in the art, and based on a reading of this detailed description, would understand that, in at least one embodiment, the components comprised in the method and tool are actually implemented in software.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. Computer code may also be written in dynamic programming languages that describe a class of high-level programming languages that execute at runtime many common behaviours that other programming languages might perform during compilation. JavaScript, PHP, Perl, Python and Ruby are examples of dynamic languages.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), and at least one communication interface. A computing device may include a memory for storing a control program and data, and a processor (CPU) for executing the control program and for managing the data, which includes user data resident in the memory and includes buffered content. The computing device may be coupled to a video display such as a television, monitor, or other type of visual display while other devices may have it incorporated in them (iPad, iPhone etc.). An application or an app or other simulation may be stored on a storage media such as a DVD, a CD, flash memory, USB memory or other type of memory media or it may be downloaded from the internet. The storage media can be coupled with the computing device where it is read and program instructions stored on the storage media are executed and a user interface is presented to a user. For example and without limitation, the programmable computers may be a server, network appliance, set-top box, SmartTV, embedded device, computer expansion module, personal computer, laptop, tablet computer, personal data assistant, game device, e-reader, or mobile device for example a Smartphone. Other devices include appliances having internet or wireless connectivity and onboard automotive devices such as navigational and entertainment systems.

The program code may execute entirely on the apparatus, or in combination with a mobile device or partly on the mobile device as a stand-alone software package; partly on the mobile device and partly on the apparatus or partly on the apparatus and partly on a remote server; or any combination thereof. The remote computer may be connected to the apparatus via the internet or may be connected to the mobile device through any type of network, including a local area network (LAN) or a wide area network (WAN), or the connection may be made to the internet through a mobile operator network (e.g. a cellular network).

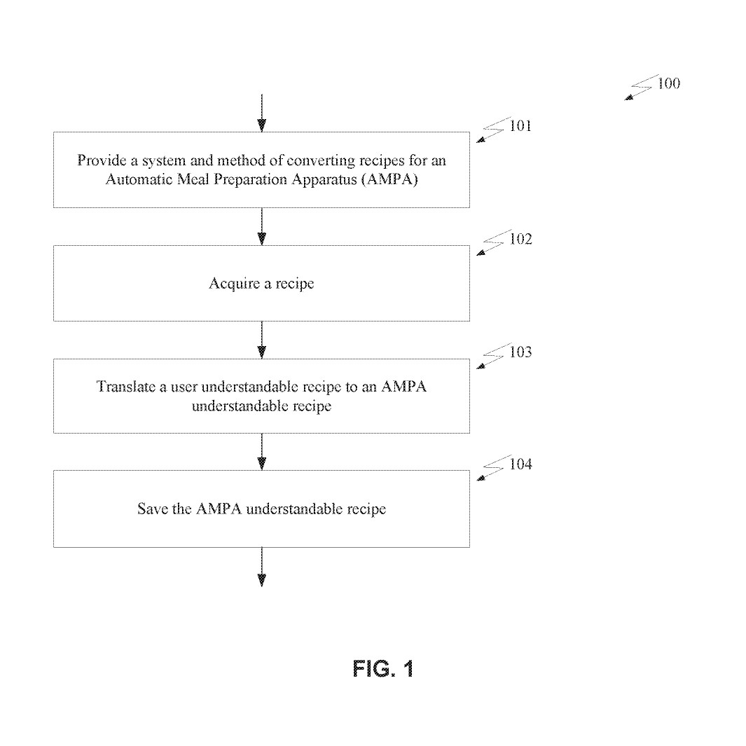

FIG. 1 shows one embodiment 100. A system and method is provided for converting recipes for an Automatic Meal Preparation Apparatus (AMPA) 101. An automatic meal preparation apparatus may be capable of preparing different recipes from various cuisines by using spices that are supplied in removable cartridges. The automatic meal preparation apparatus is computer assisted for controlling the time of cooking, intensity of heat, amount of spices, combination of spices, timing, when individual raw ingredients are to be added to the cooking vessel etc.

The apparatus, system and method of invention provide a meaningful benefit by providing a means for automatic meal preparation and have been disclosed in a previously filed USPTO patent application. One type of apparatus which can be beneficially used for the present method is disclosed in applicants' previously filed USPTO patent application Ser. No. 14/952,142 filed on Nov. 25, 2015, the contents of which are incorporated herein by reference.

A recipe is acquired 102. The recipe may be in a form that is “user understandable” and cannot be used by the Automatic Meal Preparation Apparatus (AMPA) directly e.g. a recipe in a cook book. In one embodiment the user may be able to acquire recipes from anywhere e.g. from a cookbook, a recipe book, a website, a hand written recipe from a friend, a recipe search engine, a recipe app etc. and may be able to add this into an app of invention or a Recipe Portal that implements the disclosed invention.

The user understandable recipe may be translated to an automatic meal preparation apparatus (AMPA) understandable recipe 103 that can be used by the apparatus to prepare a meal automatically.

The AMPA understandable recipe is preferably saved 104. It may be saved either in the app, the Recipe Portal, the apparatus itself or any combination of the aforementioned.

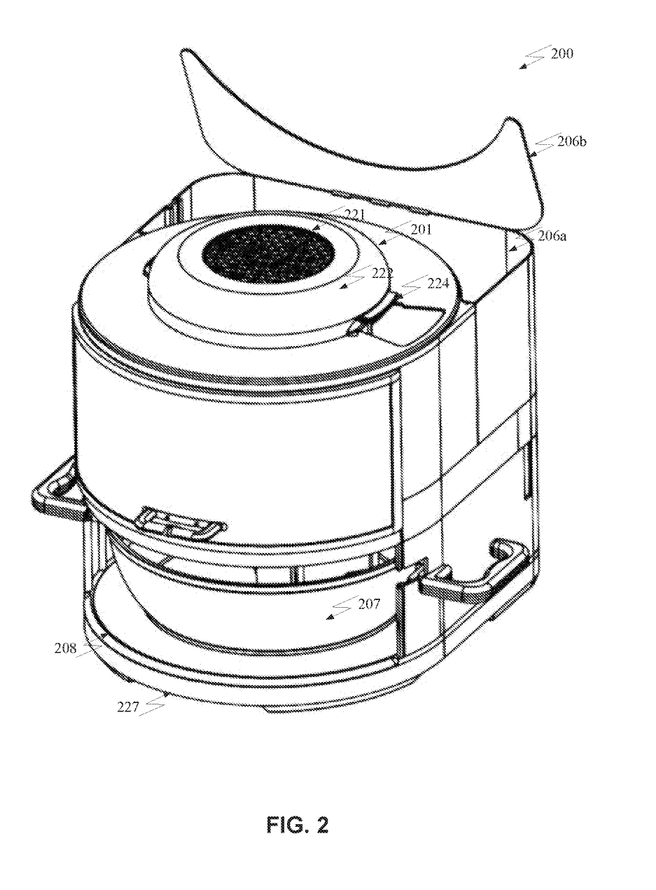

FIG. 2 shows the automatic meal preparation apparatus (AMPA) 200 which is capable of automatically preparing different recipes from various cuisines. The automatic meal preparation apparatus 200 is computer assisted for providing a no hassles experience to the user when preparing a meal.

FIG. 2 shows one embodiment of the automatic meal preparation apparatus (AMPA) 200 and its various constituent components. FIG. 2 shows spice rack 202 with lid 201 open. The lid 201 is openable and provides access to the spice rack 202, which provides the housing for the placement of the different spice cartridges 203 for dispensing spice/sauces into the cooking vessel 207.

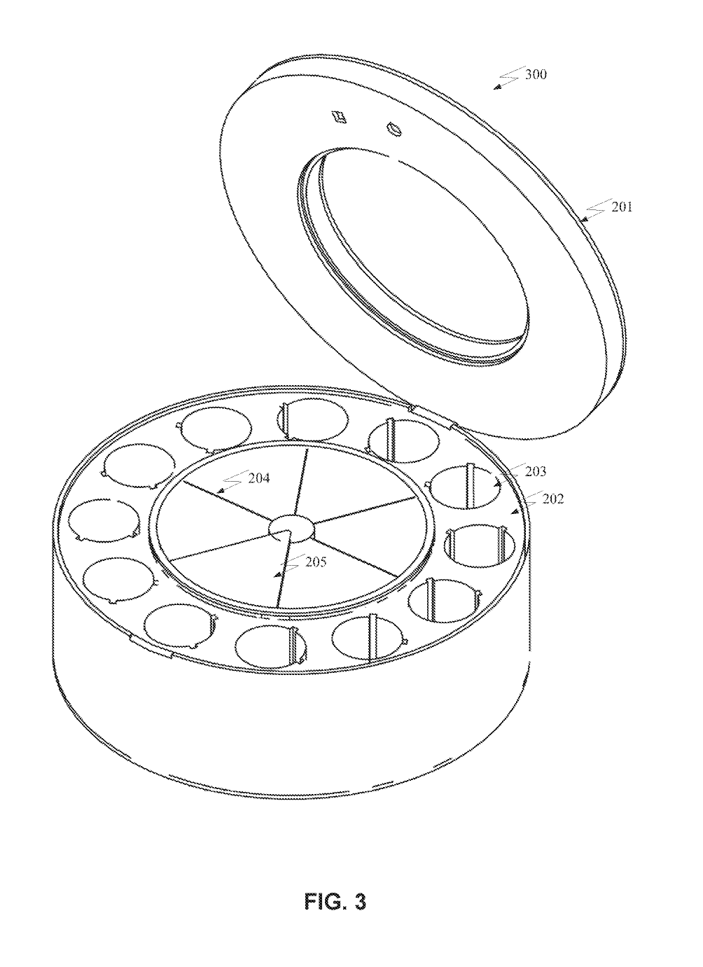

As shown in FIG. 3, the spice rack 202 is removable and provides space where several spice cartridges 203 can be removably placed. Each spice cartridge 203 many contain a different spice or sauce. A mechanical mechanism may be provided for rotating the spice rack 202 so that different spices can be dispensed into the cooking vessel 207. A spice recognition system for identifying the right spice before dispensing may also be provided.

As shown in FIG. 3, the apparatus also has a raw ingredients placement compartment 204. The raw ingredients placement compartment 204 may be divided into multiple sub-compartments for placement of raw food before cooking. An opening 205 is provided in the raw ingredients placement compartment 204 so that the user is guided to place raw ingredients one at a time in each of the separate sub-compartments which are then selectively emptied into the cooking vessel 207 as the steps of the recipe are carried out.

In one embodiment the middle section of the automatic meal preparation apparatus 200 provides a space for the placement of a cooking vessel 207 where the meal is prepared. A stirring arm (not shown) is preferably provided for stirring the ingredients in the cooking vessel.

The stirring arm is preferably actuated by a motor (not shown) in the bottom (base) section 208 of the apparatus.

In one embodiment, as shown in FIG. 2, the apparatus has a water reservoir 206a with a lid 206b. The water reservoir is preferably in selective fluid communication with the cooking vessel. The recipe may include instructions for dispensing water into the cooking vessel, or for heating the water separately to provide steam to the cooking vessel.

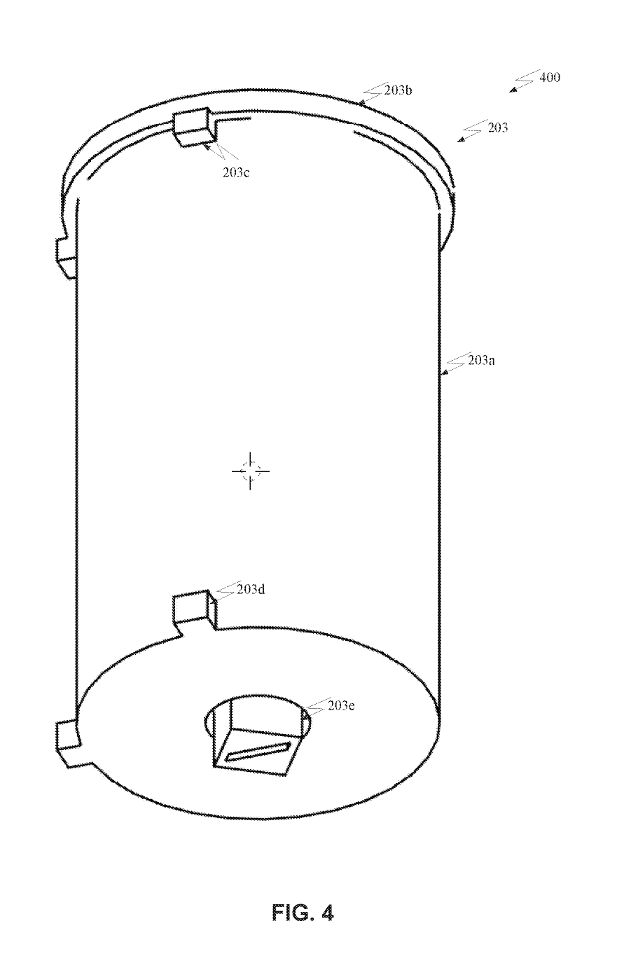

(Note that certain embodiments may also include an oil reservoir for frying applications, not shown. Alternatively, oil may be included as a spice/sauce in one of the spice/sauce cartridges, as in the example cartridge shown in FIG. 4.)

The apparatus preferably also includes a ventilation fan that is designed to keep the humidity level in the automatic meal preparation apparatus at the correct level. In addition, this fan keeps the internal temperature regulated for cooking particular types of meals.

Aspects of the ventilation system are also shown. Air enters the apparatus through vents through an intake around area 227. Air flows generally upward through the housing at a central column to exit through lid vent 221 in lid 222. The lid is openable through latch 224. A fan may be provided in the vented lid (not shown). This fan communicates with exterior vent 221. The electronics may be ventilated separately.

In one embodiment the cooking vessel 207 is heated using induction heating. The cooking vessel may be of a metallic material or another material that is induction-friendly.

The bottom section 208 houses various sub-components including the electronics for controlling the various functions of the automatic meal preparation apparatus (not shown) and the induction coils (not shown) for inducing heat in the cooking vessel 207.

The AMPA may have a display screen e.g. an LCD screen that may be used for providing visual cues and a user interface for a user interacting with the AMPA. There may be one or more buttons or other input mechanisms using which a user may be able interact with the visual interface for example by pressing a down button scroll through the local database of recipes stored in the AMPA, or enter a WFi password by pressing the buttons to cycle through a list of alphabets, digits and symbols, or receive visual alerts from the AMPA about the meal that is being prepared e.g. “Meal will be ready in 10 minutes”. The display screen may preferably be rectangular, black and white or color, and may use LCD (liquid crystal display), LED (light emitting diodes) or OLED (organic light emitting diodes) technology depending on the implementation. The display screen may be used for displaying images, icons, text and other visual clues to the user; and the invention is not limited to the examples cited here. A remote control with such controls and/or screens may also be provided.

FIG. 4 shows a bottom up view 400 of one embodiment of the spice cartridge 203. Although in this disclosure we use the term “spice cartridge” to mean a cartridge that contains an individual spice, or a combination of spices but in fact it may contain either a spice, a combination of spices, a sauce, a paste or liquids like vinegar and other ingredients that may be used in cooking e.g. food seasonings, coloring, marinates, vinaigrettes, dressings and the like. Additionally the spice cartridge may contain ground spice that is dispensed as is, or a solid spice that is ground on an as need basis before being dispensed, or a solid spice that is dispensed whole, or may contain pastes, thick liquids or gels, or may contain liquids or any other forms of solutions or emulsions containing ingredients used in meal preparation.

The spice cartridges are preferably cylindrical in shape so that they can be removably inserted into the spice rack. Each spice cartridge has an outer wall 203a, a top lid 203b that may be sealed so that the user does not have access to the spice, one or more ridges 203c and 203d to keep the spice a cartridge in place and prevent it from moving once it is placed inside the spice rack. The bottom of each spice cartridge has an opening 203e and a mechanism to dispense the spice from the selected spice cartridge into the cooking vessel.

Each spice cartridge is removable from the spice rack and has a computer controlled mechanism for selecting a spice cartridge and a mechanism for spice dispensing for the precise measurement and dispensation of the spice in the right amount and at the right time when automatically preparing a meal.

The term spice may include but is not limited to culinary herbs, spices and/or any other food or drink additives of mostly botanical origin but may include minerals like salt, used for flavoring, seasoning or coloring. Examples of some spice cartridges include but are not limited to the following: salt, pepper, Thai chill sauce, spicy red curry paste, aged cooking wine, aged soya sauce, garlic paste, ginger paste, granular sea salt, coarse ground black pepper, ground red paprika, oregano, sticks of cinnamon, whole cloves, whole black peppers etc. that are ground on demand, or dispensed from their respective cartridges whole.

The following is an exemplary categorization of different types of spice cartridges:

Ground: salt, pepper, red chillies,

Coarsely Ground: sea salt, black pepper, chilli flakes

Solids: whole black peppers, cinnamon sticks, bay leaf (solids may be dispensed as solids or as freshly ground on demand

Liquids: soya sauce, vinegar, aged olive oil,

Sauces/Thick Liquids: mustard, tomato sauce,

Pastes: garlic paste, ginger paste, wasabi, curry paste

Each spice cartridge may contain a unique code that may define its contents, its date of manufacture, its quantity, its brand, etc. In one embodiment this metadata about the spice cartridge may be saved on a server and the AMPA acquires this metadata from the server when a spice cartridge is placed in the spice rack and the top lid of the AMPA is closed. The AMPA may have sensors or electronic sub-components that may scan or read the unique code from the individual spice cartridge.

Each spice cartridge may have a code that identifies it uniquely. Such unique codes in addition to providing the spice identification, may also provide details of what kind of spice or sauce is contained in the cartridge, where the spice cartridge was purchased from, when the cartridge was manufactured, if there is an expiry date of the contents of the cartridge when does it expire, what free or paid privileges may be associated with that particular spice cartridge for example how may free recipes or free instances of a recipe can be downloaded from the recipe portal etc.

In another embodiment, the unique code of a spice cartridge may be directly read by the AMPA when the top lid of the apparatus is closed. Such automatic unique code reading may include steps like scanning the unique spice cartridge code or ID, and if the details associated with the unique code are not available locally on the AMPA acquiring the same from the recipe portal or the like by connected to the internet to access such a resource. The list of recipes may be automatically filtered so that they include only recipes that can be prepared with the spice cartridge whose unique code was scanned earlier.

FIG. 5 shows one embodiment 500 depicting a high level recipe conversion process that takes a “User Understandable Recipe” and converts it into an “AMPA Understandable Recipe”.

A user understandable recipe is first acquired 501. A typical recipe usually has two components “Ingredients List” which provides a list of ingredients that are going to be used in the recipe when cooking the meal and “Directions”; which is a list of steps for a user to follow when cooking the meal using the list of ingredients. An exemplary recipe is shown below with the list of ingredients and the steps to follow in directions:

Ingredient
6 skinless, boneless chicken breast halves
1 teaspoon garlic salt
ground black pepper to taste
2 tablespoons olive oil
1 onion, thinly sliced
1 (14.5 ounce) can diced tomatoes
½ cup balsamic vinegar
1 teaspoon dried basil
1 teaspoon dried oregano
1 teaspoon dried rosemary
½ teaspoon dried thyme

Directions
1. Season both sides of chicken breasts with garlic salt and pepper.
2. Heat olive oil in a skillet over medium heat; cook seasoned chicken breasts until chicken is browned, 3 to 4 minutes per side. Add onion; cook and stir until onion is browned, 3 to 4 minutes.
3. Pour diced tomatoes and balsamic vinegar over chicken; season with basil, oregano, rosemary and thyme. Simmer until chicken is no longer pink and the juices run clear, about 15 minutes. An instant-read thermometer inserted into the center should read at least 165 degrees F. (74 degrees C.).
4.

A machine translation process is applied 502. The Machine Translation Process implies the process of converting a “User Understandable Recipe” into an “AMPA Understandable Recipe”.

Below is an exemplary sequence of generic steps that may be used in any combination and repetition to derive an “AMPA Understandable Recipe” from the two components of a “User Understandable Recipe” namely the “Ingredients List” and the “Directions”.

Recipe
Name: name of recipe (has to be unique)
Description: brief summary of recipe
Serving_Size: 1 portion is the quantity of food suitable for 1 person
Steps
   seq—the sequence this step happens
   quantity—the amount associated in this step
   unit_of_measure—the unit used for the quantity
   command:
      Temp—adjust temperature to some degrees (this is a feedback mechanism, relying on induction coil and temperature sensor)
      Wait—no commands for x period of time
      Spice—inject/dispenses x ml of a spice or sauce
      Fresh—dispense a fresh ingredient
      Stir—mix for x seconds at y speed in z direction
      Cut—cut fresh ingredient e.g. dice, slice, cube
      Drain—release moisture or liquid to reduce

The user understandable recipe is converted into an AMPA understandable recipe 503. A typical “AMPA Understandable Recipe” may have two components “Process Steps for AMPA to Instruct User” which provides a list of steps for a user to follow when preparing and placing the fresh/raw ingredients into the AMPA; and “Process Steps for the AMAP to Prepare the Meal”; which is a list of steps for the AMPA to execute internally when preparing the meal automatically without user interaction.

For the exemplary recipe shown earlier, the conversion process is described in detail below. It is noted that in general a User Understandable Recipe typically consists of an “Ingredients List”, and “Directions”. In one embodiment the sequence of steps may be derived from the two components of the “User Understandable Recipes” namely the “Ingredients List” and the “Directions”.

An “Ingredients List” can be defined as a list of sentences, each comprised of ingredients and its respectable quantity and/or form factors typically used for shopping and preparation gathering purposes.

From the above noted exemplary User Understandable Recipe we note that the “Ingredients List” is:
6 skinless, boneless chicken breast halves
2 tablespoons of olive oil
1 teaspoon garlic salt
1 can diced tomatoes
½ cup of balsamic vinegar

Similarly “Directions” can be defined as a paragraph describing in detail how to make the meal from beginning to end, in a chorological order. In general the language consists of sentences describing one or more actions being performed by a user. Actions include how much to heat the cooking vessel, how to cut ingredients, when to add fresh ingredients, when to add spices/sauces, and when to mix sauces into fresh ingredients. In most cases, ingredients mentioned in each sentence will reference the “Ingredient List”. Sometimes a single sentence can reference multiple ingredients in the “Ingredient List”.

From the above noted exemplary User Understandable Recipe we note that the “Directions” are:
Heat olive oil in skillet on medium heat
Pour diced tomatoes and balsamic vinegar over chicken.

In one embodiment the User Understandable Recipe may be converted into an AMPA Understandable Recipe using an AMPA Recipe Language. The AMPA Recipe Language may consist of a series of single action commands in a step-by-step chorological order. Specifically, a step in the AMPA Recipe Language may be composed as follows:

[action type] [quantity] [unit of measure (opt.)] [ingrd form factors (opt.)] [ingrd. name (optional)]

Where action types are mechanisms that can be performable by the AMPA, and unit of measure is directly related to that action type. Some exemplary steps are given below:
[Inject] [2] [tsp] [olive oil]
[Heat] [150] [Celsius]
[Wait] [10] [seconds]
[Stir] [3] [minutes, fast, clockwise]
[Dispense] [500] [g] [cut in halves] [boneless chicken breast]
[Cut] [100] [cubes] [chicken]

In one embodiment the data model for the AMPA may be stored in a database or as an XML document or as a JSON.

In one embodiment the algorithm for parsing a User Understandable Recipe into AMPA Recipe Language may follow the following steps:

1. Create an array to store ingredient inventory.

2. For each bullet in Ingredient Lists, perform the following:
a. Parse into [quantity] [unit of measure] [ingredient name] using the reference tables of words, and then add each item into the inventory array.
   i. If an ingredient name is not found in the table of words, it will be added to our table. Then add to inventory array.

3. Create an array of Steps

4. For each sentence in Directions, do:
a. Lookup action words in that sentence,
b. For each action word, do:
   i. Lookup ingredient words in the sentence against the ingredient inventory array
   ii. If ingredient does not exists, then:
      1. Add new step [action] [quantity] [unit of measure] into Steps array.
   iii. Else if ingredients do exists, then:
      1. For each ingredient, then:
         a. Add new step [action] [quantity] [unit of measure] [ingredient form factor] [ingredient name] into Steps array.

Thus the exemplary recipe shown earlier would be converted to the following steps:
[Inject] [2] [tsp] [olive oil]
[Heat] [150] [Celsius]
[Wait] [10] [seconds]
[Inject] [1] [tsp] [garlic salt]
[Inject] [0.50] [tsp] [black peppers]
[Stir] [3] [minutes] [fast, clockwise]
[Heat] [80] [Celsius]
[Dispense] [500] [g] [cut in halves] [boneless chicken breast]
[Cut] [100] [cubes] [chicken]
[Stir] [3] [minutes] [medium, clockwise]
[Stir] [3] [minutes] [medium, counter clockwise]
[Dispense] [250] [g] [cut in slices] [onion]
[Heat] [60] [Celsius]
[Stir] [3] [minutes] [medium, counter clockwise]
[Dispense] [400] [g] [cut in cubes] [tomatoes]
[Inject] [0.50] [cup] [balsamic vinegar]
[Inject] [1] [tsp] [oregano]
[Inject] [1] [tsp] [basil]
[Inject] [1] [tsp] [rosemary]
[Heat] [50] [Celsius]
[Stir] [3] [minutes] [slow, clockwise]
[Stir] [3] [minutes] [slow, counter clockwise]
[Stir] [3] [minutes] [slow, clockwise]

In one embodiment the User Understandable Recipe is converted into an AMPA Understandable Recipe by first looking at the directions; separating the ingredients, their quantities and meal preparation instructions; and using a database that stores the different ingredients into an ordered list of fresh ingredients and their quantities (e.g. meats and vegetables); a list of spices and their quantities (e.g. salt % teaspoon, black pepper ¼ teaspoon, red chillies ⅓ teaspoon, cumin ½ teaspoon etc.). and meal preparation instructions e.g. order of adding ingredients, temperatures for cooking, duration for cooking, instructions for mixing the ingredients e.g. add meat, blanch over medium heat for 10 minutes while stirring gently.

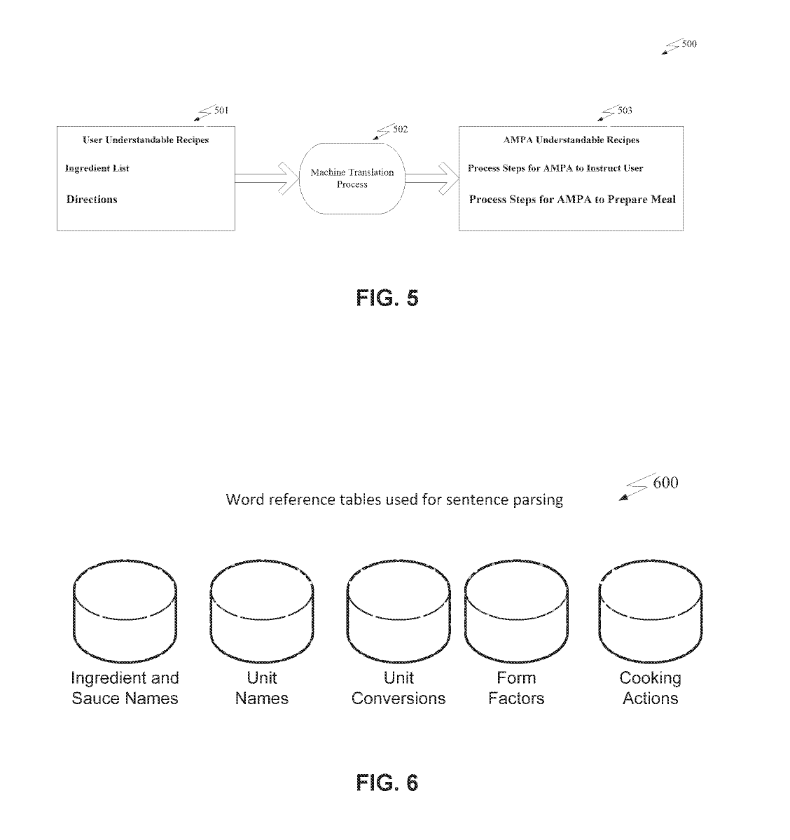

FIG. 6 shows one embodiment for storing the different ingredients and sauces, the unit names, the conversion tables, the form factors and cooking action that may be required when performing a translation.

The database may include but is not limited to the following: a list of spices and spice cartridges and their equivalents; a list of different meats e.g. beef, lamb, chicken, turkey, fish and their preparation instructions e.g. fillet, cube, mince etc. and cooking temperature and duration thresholds; a list of vegetables e.g. potatoes, cauliflower, zucchini, tomatoes, onions, etc. and their preparation instructions e.g. slice, cube, puree, chop etc. and cooking temperature and duration thresholds; a list of oils and sauces and any other kind of ingredients that may be used in meal preparations. The database may also include conversion factors for the spices e.g. 1 teaspoon is equal to 5 g dry, 1 teaspoon is equal to 5 ml liquid and 1 tablespoon is equal to 15 ml liquid etc.; a list of heating, temperature and duration conversions e.g. medium heat for 5 minutes may be converted to 45% of the induction heat for 4 minutes etc.; a list of stirring and mixing instructions and conversions e.g. stir gently for 3 minute may imply stirring at 10 RMP in clockwise direction, while stir vigorously for 5 minutes may imply stirring at 20 RMP first in clockwise and then in a anticlockwise direction.

Some exemplary conversion tables are shown below:

### Volume (Dry)

TABLE 1

| American Standard | Metric |
|---|---|
| ⅛ teaspoon | .5 ml |
| ¼ teaspoon | 1 ml |
| ½ teaspoon | 2 ml |
| ¾ teaspoon | 4 ml |
| 1 teaspoon | 5 ml |
| 1 tablespoon | 15 ml |
| ¼ cup | 59 ml |
| ⅓ cup | 79 ml |
| ½ cup | 118 ml |
| ⅔ cup | 158 ml |
| ¾ cup | 177 ml |
| 1 cup | 225 ml |
| 2 cups or 1 pint | 450 ml |
| 3 cups | 675 ml |
| 4 cups or 1 quart | 1 liter |
| ½ gallon | 2 liters |
| 1 gallon | 4 liters |

### Weight (Mass)

TABLE 2

| American Standard | Metric |
|---|---|
| (Ounces) | (Grams) |
| ½ ounce | 15 grams |
| 1 ounce | 30 grams |
| 3 ounces | 85 grams |
| 3.75 ounces | 100 grams |
| 4 ounces | 115 grams |
| 8 ounces | 225 grams |
| 12 ounces | 340 grams |
| 16 ounces or 1 pound | 450 grams |

### Volume (Liquid)

TABLE 3

| American Standard | American Standard | Metric |
|---|---|---|
| (Cups & Quarts) | (Ounces) | (Milliliters & Liters) |
| 2 tbsp | 1 fl. oz. | 30 ml |
| ¼ cup | 2 fl. oz. | 60 ml |
| ½ cup | 4 fl. oz. | 125 ml |
| 1 cup | 8 fl. oz. | 250 ml |
| 1 ½ cups | 12 fl. oz. | 375 ml |
| 2 cups or 1 pint | 16 fl. oz. | 500 ml |
| 4 cups or 1 quart | 32 fl. oz. | 1000 ml or 1 liter |
| 1 gallon | 128 fl. oz. | 4 liters |

### Dry Measure Equivalents

TABLE 4

| Teaspoons | Cups | Ounces | Grams |
|---|---|---|---|
| 3 teaspoons | 1 tablespoon | ½ ounce | 14.3 grams |
| 2 tablespoons | ⅛ cup | 1 ounce | 28.3 grams |
| 4 tablespoons | ¼ cup | 2 ounces | 56.7 grams |
| 5 ⅓ tablespoons | ⅓ cup | 2.6 ounces | 75.6 grams |
| 8 tablespoons | ½ cup | 4 ounces | 113.4 grams |
| 12 tablespoons | ¾ cup | 6 ounces | .375 pound |
| 32 tablespoons | 2 cups | 16 ounces | 1 pound |

TABLE 5

| Heat | Temperature | Induction Heating |
|---|---|---|
| Low | 50 C. | 20% |
| Medium | 75 C. | 40% |
| Medium-high | 105 C. | 60% |
| High | 120 C. | 100% |

TABLE 6

| Stir | RMP |
|---|---|
| Gently | 5 |
| Slowly | 10 |
| Moderately | 20 |
| Vigorously | 30 |

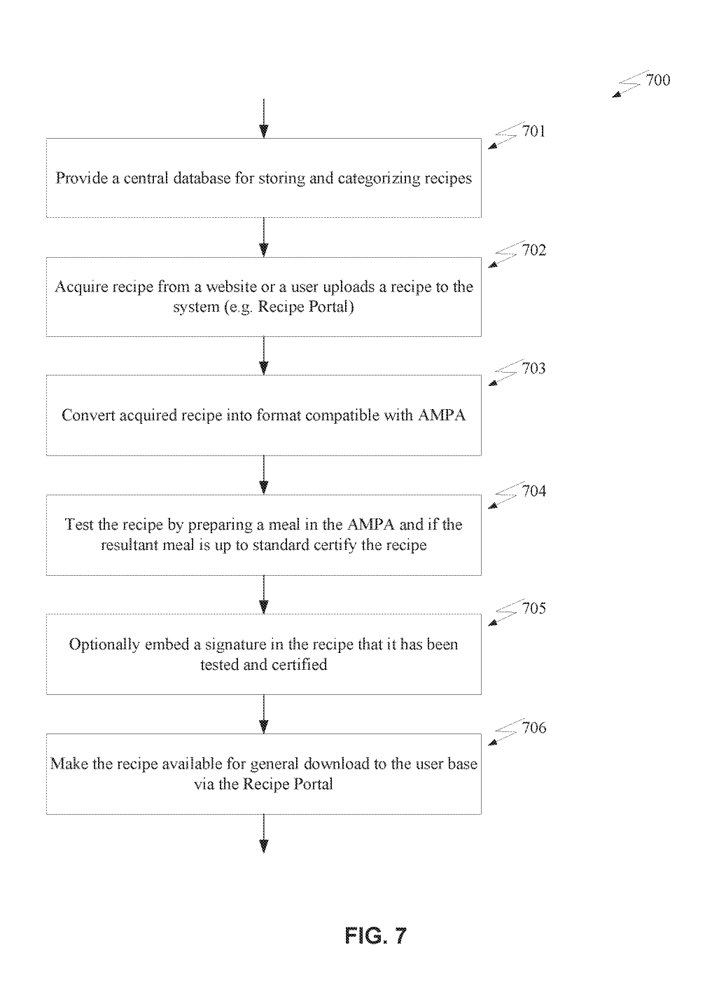

FIG. 7 shows one embodiment 700 that depicts the automated process of acquiring recipes from other websites and converting them to an AMPA understandable format.

A central database is provided for storing and categorizing recipes 701. There may be a portal that is specifically designed for converting e.g. paper based recipes into a format that is AMPA compatible, storing, categorising and making these recipes available for download by users.

A recipe is acquired from a website or a user uploads a recipe to the system (e.g. Recipe Portal) 702. In one embodiment a bot may acquire one or more recipes into the system. In one embodiment the system may be accessible via the internet and a user may use a computing device like a tablet to enter (step by step)/upload a recipe to the portal.

A bot (short for “robot”) or Internet bot, also known as web robot, VWWV robot or simply bot, is a software application that runs automated tasks over the Internet. A bot can operate as an agent for a user or another program or simulates a human activity. Typically, bots perform tasks that are both simple and structurally repetitive, at a much higher rate than would be possible for a human alone. Thus a bot is most suitable for situations that demand performing highly repetitive operations at a fast speed without requiring human intervention.

The acquired recipe is converted into a format compatible with AMPA 703. There may be checks and balances for cooking time, cooking temperatures and spice quantities, etc. The cooking time and temperature may be dependent on the type of meat and its quantity. One such exemplary recipe conversion process has been described in FIG. 5.

The recipe may be tested by preparing a meal in the AMPA and if the resultant meal is up to standard certify the recipe 704. In one embodiment the recipe testing process may be manual such that a person (tester) tests the recipe by using the Automatic Meal Preparation Apparatus (AMPA).

The recipe may be certified if the resultant meal was up to standard. The recipe certification process may be manual such that a person (tester) tests the recipe by using the Automatic Meal Preparation Apparatus (AMPA) and then tastes the resultant meal. The certification process may follow a given standard which may have criteria that needs to be satisfied before a recipe can be considered certified.

Optionally a signature may be embedded in a recipe that it has been tested and certified 705. In one embodiment the signature is encrypted so that it may not be altered or tempered with. In one embodiment the Automatic Meal Preparation Apparatus may check for the signature to ensure that the recipe is certified and will prepare a meal that will be up to standard.

The recipe may be made available for general download to the user base via the Recipe Portal 706. The recipe may be categorized and put on the portal for the general public to download and use in the Automatic Meal Preparation Apparatus (AMPA).

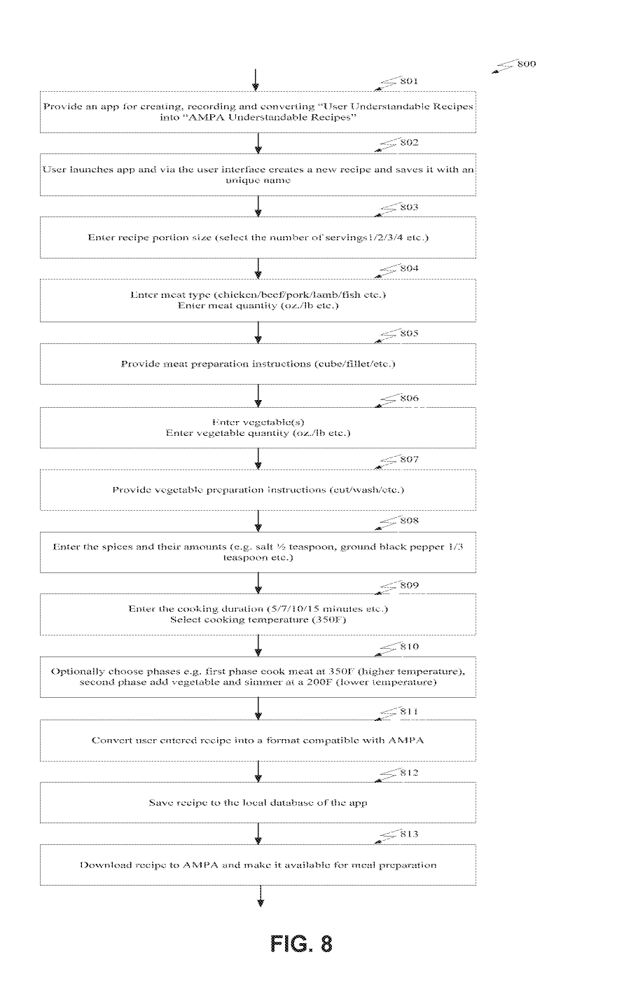

FIG. 8 shows one embodiment 800 depicting the process of a user entering a “User Understandable Recipe” into an app or a portal and having it automatically converted to an “AMPA Understandable Recipe” for use with the Automatic Meal Preparation Apparatus (AMAP). One such exemplary “User Understandable Recipe” is shown earlier in reference to FIG. 5.

An app may be provided for creating, recording and converting User Understandable Recipes into AMPA Understandable Recipes 801. Such an app may be executable on a mobile device like a tablet or a Smartphone. In another embodiment, the recipe conversion may be done using a web based portal. In both cases the creation, conversion and saving of the recipe may be a stepped process that guides the user and ensures that there are no steps missed.

The preferred embodiment may provide a companion app for the AMPA that may preferably be installed by a user on a mobile/portable device e.g. a Smartphone or a tablet. The app interface may preferably provide an interface for connecting to the AMPA, connecting to the Recipe Portal and searching, browsing and downloading different recipes. The app may also preferably be able to send the downloaded recipe(s) to the AMPA and start the meal preparation process remotely.

The companion app for the AMPA may be downloaded from an AppStore. Devices where such an app can be advantageously installed may include but not limited to an iPhone, iPad, Smartphones, Android phones, personal computers e.g. laptops, tablet computers, touchscreen computers running any number of different operating systems e.g. Android, MS Windows, Apple iOS, Linux, Ubuntu, etc.

A Recipe Portal may be provided for the convenience of users, and the users may be required to create an account, and log in using the credentials of their individual account. There may optionally be means for users to create user accounts, get subscriptions for monthly recipes, pay for the accounts and subscriptions, or pay as you go methods for receiving recipes, gift, share, exchange, trade, swap, auction, etc.

The recipe conversion process may be available to a user via a Recipe Portal. The user may access the Recipe Portal using the internet or using the companion app or directly from the automatic meal preparation apparatus. The following steps relate to a user entering a “User Understandable Recipe” into the UI for automatic conversion into an “AMPA Understandable Recipe”.

The user may launch the app and via the user interface create a new recipe and save it with a unique name 802. Saving recipes with a unique name may be required to avoid duplication and in assisting with the categorization of the recipes.

A recipe portion size is entered (select the number of servings1/2/3/4 etc.) 803; e.g. a meal for 1 person as opposed to a meal for 4 persons. The UI may provide the user with a drop down menu to select the number of persons.

A meat type is entered (chicken/beef/pork/lamb/fish etc.) and a meat quantity (oz./lb etc.) 804. In one embodiment a user selects the meat that is being used in the recipe e.g. chicken, beef, pork, lamb, fish etc. The UI may provide the user with a drop down menu to select the meat for the recipe. In one embodiment the user selects the meat quantity e.g. 8 oz. of beef or 2 lbs of fish. The UI may provide the user with a drop down menu to select the quantity and units of weight.

Meat preparation instructions may be provided (cube/fillet/etc.) 805. In one embodiment a user provides the meat preparation instructions e.g. should the meat be cut into cubes, or filleted and/or marinated in a sauce. The UI may provide the user with different options for meat preparation either in a list or a drop down menu.

Vegetable(s) and their quantities (oz./lb etc.) are entered 806. In one embodiment the user selects the vegetables that are being used in the recipe. The UI may provide the user with a drop down menu to select the different vegetables to be used in the recipe. In one embodiment the user selects the vegetable quantities e.g. 4 oz. of peas and 1 lb of potatoes.

Vegetable preparation instructions may be provided (cut/wash/etc.) 807. In one embodiment the user provides vegetable preparation instructions e.g. wash the peas and dice and wash the potatoes. The UI may provide the user with a drop down menu to select the vegetable preparation instructions.

The spices and their amounts are entered (e.g. salt ½ teaspoon, ground black pepper ⅓ teaspoon etc.) 708. In one embodiment the user enters/selects the spices and their amounts being used in the recipe e.g. ⅓ teaspoon of salt and 6 whole black peppers, 1 tablespoon of Thai chill sauce, ¼ teaspoon of spicy red curry paste and 1 tablespoon of aged cooking wine ½ teaspoon of garlic paste, ¼ teaspoon of ginger paste etc.

The cooking duration is entered (5/7/10/15 minutes etc.) 809. The user may enter/select the cooking duration e.g. cook the meat for 10 minutes then add the vegetables and cook for a further 15 minutes.

The cooking temperature is selected (350 F) 810. The UI may provide the user with a drop down menu to select the different cooking temperatures dependent on the type of meat and its quantity.

There may be optional guidelines in terms of temperature and time that depend on the type of meat and its quantity. This ensures that the user is not under-cooking or over-cooking the meat.

Optionally the user may choose phases e.g. first phase cook meat at 350 F (higher temperature), second phase add vegetable and simmer at a 200 F (lower temperature) 811. In one embodiment the recipe may require the meal to be cooked at different temperatures for different durations. For example cook the chicken at 350 F for 5 minutes, add vegetables and cook for a further 10 minutes a 250 F and then simmer at 150 F for a final 10 minutes.

The system then converts the user entered recipe into a format compatible with AMPA 811. In one embodiment the app converts the user entered “User Understandable Recipe” into a format compatible with AMPA. There may be checks and balances for cooking time, cooking temperatures and spice quantities, etc. The cooking time and temperature may be dependent on the type of meat and its quantity. A user may be able to override some or all of these thresholds, and there may be warnings provided to the user if such thresholds are ignored. One such exemplary recipe conversion process has been described with reference to FIG. 5.

The converted recipe may be stored in the local database of the app 812. In one embodiment one or more select recipes are saved to the local database of the app. When saving the recipe to the app all metadata associated with the recipe also be saved.

The recipe can be downloaded to an AMPA and made available for meal preparation 813.

In one embodiment the user selects a recipe from the companion app on the tablet. In one embodiment the user sends the selected recipe from the tablet to the automatic meal preparation apparatus. The user may send the recipe by selecting a recipe and then clicking a button “Send to AMPA”, or by performing a gesture on a touchscreen of the tablet e.g. flicking the selected recipe.

In one embodiment the recipe is received by the automatic meal preparation apparatus over the wireless connection e.g. a Bluetooth connection or a WFi connection etc. While the preferred embodiment uses Bluetooth LE for wireless connectivity between the tablet and the AMPA, in other embodiments wireless technologies like Bluetooth Classic, Near Field Communications (NFC), InfraRed (IR), WiFi Direct and the like may be used instead.

In one embodiment the downloaded recipe is saved to the local database of recipes in the automatic meal preparation apparatus and is optionally categorized based on the cuisine type, or categorized based on the ingredients, or categorized based on the calories e.g. a low calorie meal, or added alphabetically or added under a chef name etc.

In one embodiment the newly downloaded and saved recipe becomes available for meal preparation and a user can search for the recipe by name (e.g. Chilli Chicken), by cuisine type (e.g. Chinese), by calorie count (e.g. medium calorie meal), by ingredient type (e.g. chicken), by chef name (e.g. Bobby Flay) etc.

In one embodiment the newly downloaded recipes may optionally only prepare a meal a given number of times e.g. a Thai Chicken recipe may be used 10 times only and may require the purchase of additional instances of meal preparation after the initial 10 instances have been used.

In another embodiment a user may be provided with the ability to gift or share unused or extra instances of a meal preparation of a recipe to friends or family. There may means for swapping meal preparation instances where a first user may swap their extra instances of a first recipe with a second user for instances of a second recipe. The Recipe Portal may provide a means for sharing, trading, swapping, gifting of recipes or instance of recipes.

In another embodiment there may be variations with different combinations and permutations of payments and recipe conversions. For example a user may pay $1.50 for a recipe conversion; or may pay $5.00 to convert 10 recipes that can each be prepared 5 times, or for the same $5.00 may convert 5 recipes that can be prepared 10 times each or other such combinations. In yet another embodiment a user may have a monthly/yearly subscription to the recipe portal that allows the user the privilege of either a given number of free recipe conversions or unlimited recipe conversions.

In another embodiment some recipes conversion may cost more than others e.g. a simple recipe costs less to convert than a complicated recipe.

It is an object to provide an automatic meal preparation apparatus which is capable of preparing different recipes from various cuisines by using spices that are supplied in removable cartridges. The automatic meal preparation apparatus is computer assisted for controlling the time of cooking, intensity of heat, amount of spices, combination of spices, timing when individual raw ingredients are added to the cooking vessel etc.

The apparatus may be able to interact with an app installed on a device. Such devices may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having internet or wireless connectivity.

In one embodiment a specialized app is launched on a connected device. Devices that can benefit from the system may include but are not limited to a mobile device for example a Smartphone, tablet, personal data assistant (PDA), game device, e-reader, a personal computer, a server, a laptop, a tablet computer, network appliance, set-top box, SmartTV, embedded device, computer expansion module, any appliances having internet or wireless connectivity.

A Bluetooth connection may be established between the AMPA and the connected device e.g. a tablet. The Bluetooth connection request may be initiated by a user. Alternatively, the Bluetooth connection request may be initiated by the app when the app is launched.

Optionally, means may be provided for a user to set timer so that the meal can be prepared at a later time. For example prepare the meal in 2 hours or prepare the meal for 6 pm in the evening.

Once the user has executed the steps necessary for the chosen recipe, start the meal preparation process.

In one embodiment a user connects automatic meal preparation apparatus to the internet or other network e.g. a local area network (LAN). The connectivity with the internet may be via a wireless connection using Bluetooth, WiFi or other such technology, or via a hard wired LAN connection.

It should be noted that the automatic meal preparation apparatus does not require internet connection for its normal operations i.e. for meal preparation. The connectivity may be only required when new recipes are to be downloaded to it or when a user wants to initiate the meal preparation process remotely or when a software or firmware update is required.

In one embodiment a user accesses the central database of recipes using the wireless connection. The automatic meal preparation apparatus may provide a user interface and means for interacting with the user interface e.g. a built in LCD screen and buttons to navigate the list of recipes.

In one embodiment a user browses and selects a recipe from the list of recipes and the user experience of picking the recipe may include but is not limited to browsing a set of photos that show the prepared meals, either from a mobile device where the companion app is installed, or website e.g. a recipe portal which may provide means for searching recipes that have been categorized and cataloged based on a number of parameters e.g. type of cuisine, calorie count, chef, meal type (breakfast, lunch, dinner, dessert etc.), and the like.

In one embodiment the user may be able to browse and select the recipes from anywhere e.g. from the office and may be able to remotely download these to the automatic meal preparation apparatus either in real time or with a schedule e.g. select recipes during the weekdays and download the selected recipes on the weekend. Similarly, the user may also be able to schedule the automatic meal preparation apparatus to start cooking a meal based on a selected recipe from a remote location e.g. while riding a bus on the way to home.

In one embodiment the user downloads the recipe directly into the automatic meal preparation apparatus. In another embodiment the recipe may be first downloaded to a mobile device e.g. a tablet from where the recipe may be transferred to the automatic meal preparation apparatus either initiated by a user or automatically when the mobile device is in the vicinity of the automatic meal preparation apparatus using a wireless technology like Bluetooth.

Another embodiment may use WiFi as the wireless technology of choice to connect to the AMPA to the mobile device (e.g. a Smartphone or a tablet) of a user. In such an embodiment upon a first power up and successful connection to a WiFi network, the automatic meal preparation apparatus sends a ping to a central server with its public and private IP addresses and hardware identification e.g. a MAC address or other unique hardware identification. The central server is accessible over the internet and creates a new account for the said automatic meal preparation apparatus and provides the user with a user interface to enter a user name and a password to register the apparatus uniquely. Once the user has been able to enter the user name and password, the user is able to connect to the said automatic meal preparation apparatus via the internet using a browser and typing the URL for the portal e.g. www.kitchenmate.com and providing the log in credentials (user name and password). This way the user is now able to connect to his automatic meal preparation apparatus from anywhere using just a connected device with a browser e.g. a tablet with a browser. Once a user is able to connect to his automatic meal preparation apparatus, the user is able to download recipes to it, update its software or firmware, and initiate a meal preparation process either immediately or with a delay using a schedule.

In one embodiment, the user can control the automatic meal preparation apparatus in a local network without a companion app, by just using a web browser on a connected device. In one embodiment the automatic meal preparation apparatus creates an HTTP server on the local WiFi network. Upon a successful registration the public and private IP addresses along with the MAC address of the automatic meal preparation apparatus are stored and published to the central server. A user can connect to his unique automatic meal preparation apparatus from the portal e.g. www.kitchenmate.com, the central server then is able to issue commands and queries to the said automatic meal preparation apparatus using the public IP address over HTTP. In case the public IP address happens to be behind a firewall, a connection can still be made using the local network IP address and using technologies like Ajax to control it.

Thus a user can gain remote access to the his automatic meal preparation apparatus by visiting the central web application e.g. www.kitchenmate.com where queries and commands can be sent to the said automatic meal preparation apparatus connected on the same public IP address.

It is to be understood that these are exemplary methods and there may be other methods that are applicable. The intent is to cover all practical methods that may be used to implement the present method.

It should be understood that although the term application has been used as an example in this disclosure but in essence the term may also imply to any other piece of software code where the embodiments are incorporated. The software application can be implemented in a standalone configuration or in combination with other software programs and is not limited to any particular operating system or programming paradigm described here.

Several exemplary embodiments/implementations have been included in this disclosure. The application is not limited to the cited examples, but the intent is to cover all such areas that may be benefit from this invention.

The above examples are not intended to be limiting, but are illustrative and exemplary.

The examples noted here are for illustrative purposes only and may be extended to other implementation embodiments. While several embodiments are described, there is no intent to limit the disclosure to the embodiment(s) disclosed herein. On the contrary, the intent is to cover all practical alternatives, modifications, and equivalents.

What is claimed is:

1. A method of converting a recipe for use with an automatic meal preparation apparatus, comprising:
receiving text of a recipe;
separating an ingredients portion of the recipe from a directions portion of the recipe;
within the ingredients portion of the recipe:
parsing each ingredient to replace it with a standard term from a database;
standardizing a quantity and unit of the ingredient; and
identifying at least one spice/sauce from a spice/sauce cartridge database associated with the apparatus; and
within the directions portion of the recipe, parsing instructions into discrete steps including standard term instructions for:
selectively heating a heating element of the apparatus at pre-determined times;
selectively dispensing at least a portion of the ingredients by releasing them from the compartment into a cooking vessel in communication with the heating element at a pre-determined time;
selectively dispensing a pre-determined measure of the spice/sauce from at least one spice/sauce cartridge by releasing it into the cooking vessel at a pre-determined time; and
stirring and cooking the ingredients and the spice/sauce in the vessel for a specified duration, in accordance with the recipe.

2. The method of claim 1, wherein a conversion factor is applied to the quantity and the unit.

3. The method of claim 1, wherein a substitution is applied according to a database of known substitutions.

4. The method of claim 1, wherein the parsing and standardizing steps include converting the text to a machine readable format, encoding or notation.

5. The method of claim 4, wherein the format, encoding or notation comprises XML or JSON.

6. The method of claim 1, further comprising storing a converted recipe in a database for use with the apparatus.

7. The method of claim 1, further comprising categorizing a converted recipe.

8. The method of claim 1, wherein a step of the converted recipe includes a command selected from the group consisting of: heat/temp, wait/delay, inject, dispense, stir, cut, and drain.

9. The method of claim 1, wherein the steps include a sequence.

10. The method of claim 1, wherein the stir command converts to an RPM of a stirring arm of the apparatus, and a direction or directions to stir.

11. The method of claim 1, wherein an ingredient of the converted recipe includes an intended form factor of the ingredient before it is placed in the apparatus.

12. The method of claim 1, wherein a step of the converted recipe includes an addition of water or steam or oil from a reservoir.

13. The method of claim 1, wherein a step of the converted recipe includes an instruction for venting the apparatus or controlling the fan speed of the apparatus.

14. The method of claim 1, further comprising sending or making available the converted recipe to an apparatus.

15. The method of claim 1, further comprising sending the converted recipe for certification.

16. The method of claim 1, wherein receiving a recipe includes a bot acquiring a recipe.

17. The method of claim 1, wherein receiving a recipe includes a user entering a recipe.

18. The method of claim 1, wherein the method is carried out at least in part on a portal, on an app, or on an automatic meal preparation apparatus.

19. The method of claim 1, wherein the converted recipe is saved at least in part on a portal, on an app, or on an automatic meal preparation apparatus.

20. The method of claim 19, wherein the converted recipe is made available for sharing once saved.

21. The method of claim 14, further comprising allowing the converted recipe to be personalized by the user of the apparatus prior to use.

22. The method of claim 1, further comprising charging a user for conversion of the recipe.

23. The method of claim 2, wherein the conversion factor is used to change the quantity or servings of the recipe.
